(19) United States
(12) Patent Application Publication
(10) Pub. No.: US 2015/0378137 A1
(43) Pub. Date: Dec. 31, 2015

(54) Imaging Lens and Imaging Device

(71) Applicant: Tamron Co., Ltd., Saitama-shi (JP)

(72) Inventor: Yasuhiko Obikane, Saitama-shi (JP)

(21) Appl. No.: 14/506,398

(22) Filed: Oct. 3, 2014

(30) Foreign Application Priority Data
Oct. 7, 2013 (JP) 2013-209757

(51) Int. Cl. G02B 13/24; G02B 7/08; G02B 13/02; G02B 13/18; G02B 27/00; G02B 9/64

(52) U.S. Cl. CPC G02B 13/24; G02B 27/0025; G02B 9/64; G02B 13/02; G02B 13/18; G02B 7/08

(57) ABSTRACT

A telephoto-type imaging lens for short-distance imaging which realizes well focused image with a simple structure through the miniaturization and weight reduction of a focusing lens group, reduction of the load on a drive system for focusing and compact structure of the entire optical system; and an imaging device. The imaging lens includes a first lens group having positive refracting power, a second lens group having negative refracting power and a third lens group having positive refracting power are disposed in order from the object side, wherein at least one positive lens constitutes the second lens group, the first lens group and the third lens group are fixed and the second lens group moves to a focusing side in focusing from infinity to a close object.

### CROSS-REFERENCE TO RELATED APPLICATION

This application claims priority to Japanese Patent Application No. 2013-209757 filed Oct. 7, 2013, the disclosure of which is hereby incorporated in its entirety by reference.

### BACKGROUND OF THE INVENTION

1. Field of the Invention

The present invention relates to an imaging lens and an imaging device, and especially relates to an imaging lens suitable for a lens-interchangeable-type camera and an imaging device including the imaging lens.

2. Background Art

In an imaging lens for short-distance imaging, various lens structures and focusing methods have been proposed to reduce fluctuation of aberration in focusing to provide well focused image.

For example, in a telephoto lens disclosed in Japanese Patent Laid-Open No. H8-248305, a three-group structure constituted by a positive/positive/negative is employed. And in focusing from the infinity to a short-distance, a plurality of lens groups are floated along an optical axis to make gaps among lens groups satisfy a predetermined condition. As a result, excellent aberration correction can be performed even in short-distance imaging and provides well focused image.

However, in the telephoto lens disclosed in this Japanese Patent Laid-Open No. H8-248305, the total optical length changes depending on the movement of a lens group in focusing. So, a lens barrel is hard to have a sealed structure, and environment refuse may enter in the lens barrel through a gap. Further, as the entire length of the lens barrel changes in focusing, the tip of a lens may contact to an object depending on the imaging distance and the position of the object to make the object and/or the lens broken or contaminated. Further, the outer diameter of lenses constituting the first lens group should be large and heavy since the incident pupil diameter of the telephoto lens is large. So, when the first lens group moves in focusing, the lens barrel or the main body of the imaging device may be shaken to cause blur in an image since the barycentric position moves in the entire optical system. As described above, the telephoto lens disclosed in Japanese Patent Laid-Open No. H8-248305 may be hard to support the speed-up of auto-focusing and video-imaging.

As one of countermeasures to solve such a problem, a lens structure and focusing method disclosed in Japanese Patent Laid-Open No. 2010-181634 can be exemplified. The imaging lens disclosed in Japanese Patent Laid-Open No. 2010-181634 employs a lens structure including a first lens group having positive refracting power, a second lens group having negative refracting power, a third lens group having positive refracting power and a subsequent lens group following the third lens group; and the first lens group is fixed, the second lens group moves to the focusing side and the third lens group moves to the object side in focusing from the infinity to a close object. That is, movement of the barycentric position is reduced without total optical length change and the above problem is solved since a focusing method of a so-called inner focus type which moves only an inner lens group in focusing is employed. At the same time, floating of other lens groups excluding the first lens group in focusing may achieve excellent aberration correction in short-distance imaging and well focused image can be provided the same as above.

However, although the imaging lens disclosed in Japanese Patent Laid-Open No. 2010-181634 is a telephoto lens, it is difficult to raise a so-called telephoto ratio since a second negative lens group having strong refracting power is disposed closer to the object side than an optical iris. So, it is difficult to achieve downsized structure, short entire length against the focal length and reduced outer diameter of the lens. Further, problems including complicated drive mechanism for focusing and load increase in control arise depending on movement control of each lens group since a plurality of lens groups should move in focusing.

In contrast, the imaging lens disclosed in Japanese Patent Laid-Open No. 2012-255842 employs three lens groups structure and just a second lens group having positive refracting power moves in focusing. Load reduction in the drive system for focusing and downsized structure are achieved because focusing lens group include one lens group. However, as the focusing lens group is a positive lens in the imaging lens disclosed in Japanese Patent Laid-Open No. 2012-255842, outer diameter of the focusing lens group is almost the same as other lens groups. That is, problems including insufficient miniaturization of the focusing lens group and heavy weight arises because the focusing lens is a positive lens. That is, further miniaturization and weight reduction are demanded on the focusing lens group to achieve high-speed focusing.

Note that a three lens group structure constituted by positive/negative/positive is employed and just a second lens group having negative refracting power moves in focusing as disclosed in Japanese Patent Laid-Open No. 2012-159613 can be exemplified to realize high-speed focusing. The imaging lens disclosed in Japanese Patent Laid-Open No. 2012-159613 is compact because of such lens structure and excellent in image focusing. Further, miniaturization and weight reduction of the focusing lens group is achieved by making the second lens group as the focusing lens group a negative lens, and load on the drive system for focusing is greatly reduced.

However, as the imaging lens disclosed in Japanese Patent Laid-Open No. 2012-159613 is a lens with a standard angle of view, it is difficult to apply the lens structure and focusing method disclosed in Japanese Patent Laid-Open No. 2012-159613 to a telephoto lens as it is. It is because, as spherical aberration, focus distortion and on-axis chromatic aberration increase caused by the imaging distance change in the telephoto lens as compared with wide-angle and standard lenses, if a focusing lens group is constituted by one negative lens, sufficient correction of the various aberrations is made difficult especially in short-distance imaging to hardly provide well focused image.

Japanese Patent Publication No. 3733164 discloses a telephoto lens that enables short-distance imaging in which a focusing lens group is assumed to be one lens group and the lens group is constituted by a positive lens and a negative lens. Employment of such lens structure and the focusing method achieves miniaturization and weight reduction of the focusing lens group reduces the load on the drive system, and the speed-up of focusing is achieved. At the same time, correction of various aberrations including the spherical aberration, focus distortion and on-axis chromatic aberration caused by the imaging distance change is made possible since the focusing lens group is constituted by two lenses of positive and negative ones.

However, the telephoto lens disclosed in Japanese Patent Publication No. 3733164 has problems that as the lateral magnification of a fixed lens group disposed at the focusing side of the focusing lens group is small, the total optical length should be long to realize a bright telephoto lens since the number of lenses constituting the telephoto lens increases.

### DOCUMENTS CITED

### Patent Documents

Patent Document 1: Japanese Patent Laid-Open No. H8-248305
Patent Document 2: Japanese Patent Laid-Open No. 2010-181634
Patent Document 3: Japanese Patent Laid-Open No. 2012-255842
Patent Document 4: Japanese Patent Laid-Open No. 2012-159613
Patent Document 5: Japanese Patent Publication No. 3733164

An object of the present invention is set in view of the above problems and to provide a telephoto-type imaging lens which enables short-distance imaging and especially achieve the miniaturization and weight reduction of a focusing lens group, reduce the load on a drive system for focusing, make the entire optical system compact, and realize well focused image with a simple structure; and an imaging device.

### SUMMARY OF THE INVENTION

As a result of conducting hard research, the present inventors have achieved the above object by employing the following lens structure and focusing method.

The imaging lens according to the present invention includes a first lens group having positive refracting power, a second lens group having negative refracting power and a third lens group having positive refracting power disposed in order from an object side, wherein at least one positive lens constitutes the second lens group; the first lens group and the third lens group are fixed and the second lens group moves to an focusing side in focusing from infinity to a close object; and the imaging lens satisfies the conditional expressions (1) and (2) below.

0.50≦|B| (1)

0.70≦f3/f≦6.00 (2)

where
B: Maximum lateral magnification of entire optical system
f3: Focal length of third lens group
f: Focal length of entire optical system at infinity focusing

The imaging lens according to the present invention includes a first lens group having positive refracting power, a second lens group having negative refracting power and a third lens group having positive refracting power disposed in order from an object side, wherein at least one positive lens constitutes the second lens group; the third lens group includes a front sub-lens group having positive refracting power disposed at an object side and a rear sub-lens group having negative refracting power disposed at an focusing side with a largest on-axis air gap in the third lens group; the first lens group and the third lens group are fixed and the second lens group moves to the focusing side in focusing from infinity to a close object; and the imaging lens satisfies the conditional expressions (1) and (3) below;

0.50≦|B| (1)

0.30≦f3f/|f3r|≦1.40 (3)

where
B: Maximum lateral magnification of entire optical system
f3f: Focal length of front sub-lens group of third lens group
f3r: Focal length of rear sub-lens group of third lens group

The imaging lens according to the present invention is preferable to satisfy conditional expression (4) below:

0.19≦|f2|/f≦0.90 (4)

where
f2: Focal length of second lens group
f: Focal length of entire optical system in infinity focusing

The imaging lens according to the present invention is preferable to satisfy conditional expression (5) below:

0.70≦f2p/|f2|≦2.20 (5)

where
f2p: Focal length of positive lens in second lens group
f2: Focal length of second lens group

The imaging lens according to the present invention is preferable to satisfy conditional expression (6) below:

0.15≦|B3|≦0.90 (6)

where
B3: Lateral magnification at infinity focusing of third lens group

The imaging lens according to the present invention is preferable to satisfy conditional expression (7) below:

0.28≦f1/f≦0.80 (7)

where
f1: Focal length of first lens group
f: Focal length of entire optical system at infinity focusing

The imaging device according to the present invention includes the above imaging lens and an imaging sensor that converts an optical image formed on the focusing side by the imaging lens into an electrical signal.

According to the present invention, employment of the lens structure and focusing method described above achieves the miniaturization and weight reduction of a focusing lens group to reduce the load on a drive system for focusing, and makes the entire optical system compact and realize excellent image formation performance in a simple structure in a telephoto-type imaging lens for short-distance imaging and an imaging device.

### BRIEF DESCRIPTION OF THE DRAWINGS

FIG. 1 is a figure exemplifying a lens structure of the imaging lens in Example 1 of the present invention, where the top is a lens structure at the infinity object distance and the bottom is a lens structure at the closest object distance;

FIG. 2 is a longitudinal aberration diagram of spherical aberration, astigmatism aberration and distortion aberration in image size “0 times (Infinity)” of the imaging lens in Example 1 of the present invention;

FIG. 3 is a longitudinal aberration diagram of spherical aberration, astigmatism aberration and distortion aberration in image size “−0.5 times” of the imaging lens in Example 1 of the present invention;

FIG. 4 is a longitudinal aberration diagram of spherical aberration, astigmatism aberration and distortion aberration in image size “−1.0 times” of the imaging lens in Example 1 of the present invention;

FIG. 5 is a figure exemplifying a lens structure of the imaging lens in Example 2 of the present invention, where the top is a lens structure at the infinity object distance and the bottom is a lens structure at the closest object distance;

FIG. 6 is a longitudinal aberration diagram of spherical aberration, astigmatism aberration and distortion aberration in image size “0 times (Infinity)” of the imaging lens in Example 2 of the present invention;

FIG. 7 is a longitudinal aberration diagram of spherical aberration, astigmatism aberration and distortion aberration in image size “−0.5 times” of the imaging lens in Example 2 of the present invention;

FIG. 8 is a longitudinal aberration diagram of spherical aberration, astigmatism aberration and distortion aberration in image size “−1.0 times” of the imaging lens in Example 2 of the present invention;

FIG. 9 is a figure exemplifying a lens structure of the imaging lens in Example 3 of the present invention, where the top is a lens structure at the infinity object distance and the bottom is a lens structure at the closest object distance;

FIG. 10 is a longitudinal aberration diagram of spherical aberration, astigmatism aberration and distortion aberration in image size “0 times (Infinity)” of the imaging lens in Example 3 of the present invention;

FIG. 11 is a longitudinal aberration diagram of spherical aberration, astigmatism aberration and distortion aberration in image size “−0.5 times” of the imaging lens in Example 3 of the present invention;

FIG. 12 is a longitudinal aberration diagram of spherical aberration, astigmatism aberration and distortion aberration in image size “−1.0 times” of the imaging lens in Example 3 of the present invention;

FIG. 13 is a figure exemplifying a lens structure of the imaging lens in Example 4 of the present invention, where the top is a lens structure at the infinity object distance and the bottom is a lens structure at the closest object distance;

FIG. 14 is a longitudinal aberration diagram of spherical aberration, astigmatism aberration and distortion aberration in image size “0 times (Infinity)” of the imaging lens in Example 4 of the present invention;

FIG. 15 is a longitudinal aberration diagram of spherical aberration, astigmatism aberration and distortion aberration in image size “−0.5 times” of the imaging lens in Example 4 of the present invention;

FIG. 16 is a longitudinal aberration diagram of spherical aberration, astigmatism aberration and distortion aberration in image size “−1.0 times” of the imaging lens in Example 4 of the present invention;

FIG. 17 is a figure exemplifying a lens structure of the imaging lens in Example 5 of the present invention, where the top is a lens structure at the infinity object distance and the bottom is a lens structure at the closest object distance;

FIG. 18 is a longitudinal aberration diagram of spherical aberration, astigmatism aberration and distortion aberration in image size “0 times (Infinity)” of the imaging lens in Example 5 of the present invention;

FIG. 19 is a longitudinal aberration diagram of spherical aberration, astigmatism aberration and distortion aberration in image size “−0.5 times” of the imaging lens in Example 5 of the present invention; and

FIG. 20 is a longitudinal aberration diagram of spherical aberration, astigmatism aberration and distortion aberration in image size “−1.0 times” of the imaging lens in Example 5 of the present invention.

### DETAILED DESCRIPTION

Embodiments of the imaging lens and imaging device according to the present invention will be described.

### 1. Imaging Lens

The imaging lens according to the present invention includes a first lens group having positive refracting power, a second lens group having negative refracting power and a third lens group having positive refracting power disposed in order from the object side, wherein at least one positive lens constitutes the second lens group, the first lens group and the third lens group are fixed and the second lens group moves to the focusing side at focusing from the infinity to a close object and satisfies conditional expressions described later.

### 1-1. Structure of Optical System

The structure of an optical system of the imaging lens will be described.

### (1) First Lens Group

If the first lens group has positive refracting power, the specific lens structure is not especially limited as long as satisfies following conditional expressions (1) and (2). The first lens group is preferable to have strong positive refracting power to make the telephoto ratio large.

### (2) Second Lens Group

If the second lens group has negative refracting power and includes at least one positive lens, the specific lens structure is not especially limited as long as satisfies following conditional expressions (1) and (2). In the present invention, since at least one positive lens constitutes the second lens group as a focusing lens group, correction of on-axis chromatic aberration and magnification chromatic aberration is made easy by the positive lens. Employment of the present structure makes correction of various aberrations including spherical aberration, focus distortion and on-axis chromatic aberration caused by the imaging distance change easy, and realize well focused image among entire imaging distance.

In the present invention, the positive lens constituting the second lens group is a positive lens as a unit element. Note that if the second lens group includes a cemented lens and a composite aspherical lens in which a plurality of an optical elements are pasted at a lens surface, the unit element denotes a plurality of an optical element constituting a cemented lens etc. In the cemented lens, each single lens before pasting corresponds to a unit element; and in the compound aspherical lens, a single lens before providing an aspheric surface film corresponds to a unit element. That is, the unit element in the present invention denotes one optical element before pasting or the like, and the second lens group should be constituted by at least one unit element having positive refracting power.

In the present invention, the position of the positive lens constituting the second lens group is not especially limited. The positive lens may be disposed closest to the object side or closest to the focusing side among a plurality of lenses constituting the second lens group. If the second lens group is constituted by three or more lenses as a unit element, the positive lens may be disposed between other lenses (other lenses as a unit element) in the second lens group. In any case, an effect of the present invention can be achieved.

### (3) Third Lens Group

If the third lens group has positive refracting power, the specific lens structure is not especially limited as long as satisfies following conditional expressions (1) and (2).

A specific structure exemplifying the third lens group in the present invention may be constituted by a front sub-lens group having positive refracting power disposed at the object side and a rear sub-lens group having negative refracting power disposed at the focusing side with the largest on-axis air gap in the third lens group. Employment of the structure constituted by the front sub-lens group and the rear sub-lens group with the largest on-axis air gap can make exit pupil distance short. As a result, diameter of a lens disposed close to the image side is made small to make an imaging lens suitable for an imaging device having a small mount diameter. Further, since such structure itself is a telephoto structure, the imaging lens is easily made to be telephoto. If the third lens group employs such structure, conditional expression (2) should not to be satisfied since the third lens group is required to satisfy conditional expression (3) described later instead of conditional expression (2). The matter will be described later.

### (4) Optical Iris

In the present invention, the position of an optical iris is not especially limited. The position is not limited and includes in the first lens group, in the second lens group, in the third lens group and between lens groups. If an optical iris is disposed at any position, an optical effect according to the present invention can be achieved. Further, the optical iris may be fixed against an imaging surface or may be movable. For example, although it is preferable to move the optical iris to perform peripheral light quantity adjustment and aberration correction in short-distance imaging, the optical iris can be arbitrary made fix or move according to the optical requirement on the imaging lens. However, if the weight including a mechanism for changing the opening diameter of the optical iris is relatively heavy, it is preferable to dispose the optical iris at positions excluding the second lens group from the viewpoint that the load on a drive system for focusing is reduced regardless the optical iris is fixed or moved. The matter will be described later.

The imaging lens according to the present invention employs a three-group structure of positive/negative/positive in order from the object side as described above. Arrangement of the refracting powers in the optical system in this way makes increase of the telephoto ratio easy, increase in the total optical length against the focal length is reduced and the lens barrel diameter and the entire length of the lens barrel is made compact. So, if the imaging lens according to the present invention is applied to a telephoto-type lens, entire size is made compact. Note that the telephoto-type lens in the present invention denotes an imaging lens with a relatively long focal length including a medium telephoto lens and a telephoto lens.

In contrast, if the first lens group disposed closest to the object side is a negative lens group different from the present invention, increase of the telephoto ratio is made difficult and reduction of an increase in the total optical length against the focal length is made difficult. So, if such refracting powers arrangement is employed, application to a telephoto-type lens is made difficult. If the second lens group is a positive lens group, decrease of the load on the drive system for focusing is made difficult since the outer diameter and weight of lenses constituting the second lens group is made larger than where the second lens group is a negative lens group. If the third lens group is a negative lens group, the second lens group as a focusing lens group having negative refracting power is disposed closer to the object side than the third lens group disposed closest to the focusing side. So, the outer diameter of the first lens group should be large to focus an image of a close object on the focusing plane and to make an optical system bright. So, if the third lens group is a negative lens group, the brightness in the imaging lens is made insufficient, the imaging lens is hardly made compact, and furthermore, correction of spherical aberration is made difficult.

### 1-2. Focusing Method

Focusing method will be described. The imaging lens according to the present invention employs the lens structure described above, and the first lens group disposed closest to the object side and the third lens group disposed closest to the focusing side are fixed and the second lens group disposed between moves as a focusing lens group in focusing from the infinity to a close object.

As a focusing method of a so-called inner focus type is employed in the present invention, a lens barrel can have a sealed structure since the total optical length in focusing does not change. So, the lens barrel is prevented from invasion of dust and refuse through the gap. Further, the object and/or the lens may be prevented from breaking and/or contamination caused by contacting of the tip of the optical system to an object in focusing in short-distance imaging because of the fixed entire length of the lens barrel. So, the lens barrel is suitably applicable to a short-distance imaging lens, so called a macro lens used for imaging at close to the object.

Further, the outer diameter and weight of lenses constituting the second lens group are smaller than the outer diameters and weights of lenses constituting the first lens group and the third lens group since the present invention employs the lens structure described above. So, as miniaturization and weight reduction of lenses constituting the focusing lens group is made easy as compared with a case where the first lens group and/or the third lens group are/is a focusing lens group(s), the load on the drive system for focusing is reduced.

Furthermore, if the lens structure described above is employed in the telephoto-type lens, the outer diameters and weights of the lenses constituting the first and third lens groups that are positive lens groups should be rather large. The barycentric position change in the optical system in focusing can be reduced in the present invention since the first lens group and the third lens group are fixed lens groups. As described above, as the imaging lens according to the present invention reduces shaking in the lens barrel or the main body of the imaging device in focusing, high-speed auto-focusing and prompt focusing on the object following the movement of the object in video-imaging are made easy.

Note that the position of the optical iris in the optical system is arbitrary as described above. However, from the viewpoint including reduction of the load on the drive system for focusing, realization of high-speed auto-focusing and video-imaging; disposition of the optical iris in the second lens group is not preferable as described above. If the optical iris is disposed in the second lens group, the load on the drive system for focusing increases by the optical iris since the optical iris should move together with each lens constituting the second lens in focusing.

Further, the optical iris is arbitrary fixed or moved as described above. However, if the optical iris moves, it is preferable to drive the optical iris by a drive system different from the drive system for focusing which move the second lens group as the focusing lens group. The purpose is to reduce the load on the drive system for focusing.

### 1-3. Conditional Expression

Conditional expressions will be described. The imaging lens according to the present invention is characterized in employing the lens structure and focusing method described above and satisfying following conditional expressions (1) and (2).

0.50≦|B| (1)

0.70≦f3/f≦6.00 (2)

where
B: Maximum lateral magnification of entire optical system
f3: Focal length of third lens group
f: Focal length of entire optical system at infinity focusing

### 1-3-1. Conditional Expression (1)

Conditional expression (1) will be described. Conditional expression (1) is an expression that defines that the imaging lens according to the present invention is a lens for short-distance imaging, so called a macro lens for imaging an object of the same size or almost the same size on the focusing plane. In the imaging lens according to the present invention, satisfaction of conditional expression (1) realizes well focused image with a simple structure through employing the lens structure and focusing method described above; and satisfaction of conditional expression (2) described below realizes miniaturization and weight reduction of focusing lens groups, reduction of the load on the drive system for focusing and compact structure in the entire optical system.

Especially, in the imaging lens according to the present invention, the value of conditional expression (1) is more preferable to be in the range of following expression (1a) and further preferable to be in the range of following expression (1b).

0.75≦|B| (1a)

0.90≦|B| (1b)

### 1-3-2. Conditional Expression (2)

Conditional expression (2) defines the ratio between the focal length of the third lens group and the focal length of the entire optical system at the infinity focusing. If the conditional expression (2) is satisfied, appropriateness in the total optical length and aberration correction are achieved since the focal length of the third lens group is made to be a proper value. If the value is less than the lower limit value of conditional expression (2), the focal length of the third lens group is too short and the positive refracting power of the third lens group is made too strong. If so, the telephoto effect is made insufficient since a lens group at the focusing side has strong positive refracting power and the total optical length against the focal length of the entire optical system is made long. So, it is not preferable for realization of the telephoto type imaging lens. In contrast, if the value exceeds the upper limit value of conditional expression (2), the focal length of the third lens group is made too long and the refracting power of the third lens group is made weak. If so, the F-number in the entire optical system tends to increase. So, the number of lenses required for aberration correction increases for realization of an imaging lens bright and excellent in well focused image. Especially, the number of lenses constituting the first lens group and the second lens group should be increased. That is, the entire optical length is made long since the number of lenses constituting an imaging lens increases to result difficulty in making of the imaging lens structure compact and sufficient reduction of the load on the drive system for focusing.

In view of these viewpoints, the value of conditional expression (2) is more preferable to be in the following expression (2a) and is further preferable to be in the following expression (2b).

0.80≦f3/f≦5.00 (2a)

0.85≦f3/f≦4.50 (2b)

### 1-3-3. Conditional Expression (3)

If the third lens group is constituted by the front sub-lens group having positive refracting power disposed at the object side and the rear sub-lens group having negative refracting power disposed at the focusing side with the largest on-axis air gap in the third lens group as described above, the imaging lens according to the present invention satisfy conditional expression (1) described above and conditional expression (3) (see the expression below). If so, although it is more preferable to further satisfy conditional expression (2), the equivalent effect when conditional expression (3) is satisfied is achieved even if conditional expression (2) is not satisfied.

0.50≦|B| (1)

0.30≦f3f/|f3r|≦1.40 (3)

where
B: Maximum lateral magnification of entire optical system
f3f: Focal length of front sub-lens group of third lens group
f3r: Focal length of rear sub-lens group of third lens group

Conditional expression (3) defines the ratio between the focal length of the front sub-lens group in the third lens group and the focal length of the rear sub-lens group in the third lens group. If the conditional expression (3) is satisfied, balance between the total optical length and peripheral light quantity is made appropriate since the ratio between the focal lengths of these sub-lenses in the third lens group is made proper. If the value is less than the lower limit value of conditional expression (3), the positive refracting power of the front sub-lens group is made too strong. As a result, a lens group close to the image side has strong positive refracting power to make the telephoto effect insufficient and the total optical length against the focal length of the entire optical system is made long. So, it is not preferable to realize the imaging lens of the telephoto type. In contrast, if the value exceeds the upper limit value of conditional expression (3), a negative refracting power of the rear sub-lens group is too strong. If so, it is not preferable because of a decreased quantity of light especially due to the imbalance of the pupil at the periphery since the short exit pupil distance makes the angle of incident light on a solid photographing element (solid imaging sensor) such as a CCD disposed at the focusing plane oblique.

In view of these viewpoints, the value of conditional expression (3) is more preferable to be in the range of following expression (3a), and is further preferable to be in the range of following expression (3b).

0.40≦f3f/|f3r|≦1.30 (3a)

0.50≦f3f/|f3r|≦1.25 (3b)

### 1-3-4. Conditional Expression (4)

Conditional expression (4) will be described. The imaging lens according to the present invention is preferable to further satisfy following conditional expression (4) together with conditional expression (1) and (2) or conditional expression (1) and (3) described above.

0.19≦|f2|/f≦0.90 (4)

where
f2: Focal length of second lens group
f: Focal length of entire optical system in infinity focusing

Conditional expression (4) defines the ratio between the focal length of the second lens group and the focal length of the entire optical system at the infinity focusing. If the value is less than the lower limit value, the power of the second lens group is too strong and correction of aberration including spherical aberration and focus distortion among object distance is made insufficient. In contrast, if the value exceeds the upper limit value, the movement of the second lens group required for focusing increases since the power of the second lens group is too weak and results difficulty in miniaturization of the total optical length.

In view of these viewpoints, the value of conditional expression (4) is more preferable to be in the range of following expression (4a) and is further preferable to be in the range of following expression (4b).

0.21≦|f2|/f≦0.75 (4a)

0.23≦|f2|/f≦0.70 (4b)

### 1-3-5. Conditional Expression (5)

Conditional expression (5) will be described. The imaging lens according to the present invention is preferable to further satisfy following conditional expression (5) together with conditional expression (1) and (2) or conditional expression (1) and (3) described above.

0.70≦f2p/|f2|≦2.20 (5)

f2p: Focal length of positive lens in second lens group
f2: Focal length of second lens group

Conditional expression (5) defines the ratio between the focal length of a positive lens in the second lens group and the focal length of the second lens group. If the value is less than the lower limit value, the movement of the second lens group required for focusing increases since the power of the second lens group is too weak and results difficulty in miniaturization of the total optical length. In contrast, if the value exceeds the upper limit value, correction of the aberration including spherical aberration and focus distortion among object distance is made insufficient since the power of the positive lens in the second lens group is too weak.

In view of these viewpoints, the value of conditional expression (5) is more preferable to be in the range of following expression (5a) and further preferable to be in the range of following expression (5b).

0.73≦f2p/|f2|≦1.95 (5a)

0.76≦f2p/|f2|≦1.85 (5b)

### 1-3-6. Conditional Expression (6)

Conditional expression (6) will be described. The imaging lens according to the present invention is preferable to further satisfy following conditional expression (6) together with conditional expression (1) and (2) or conditional expression (1) and (3) described above.

0.15≦|B3|≦0.90 (6)

where
B3: Lateral magnification at infinity focusing of third lens group

Conditional expression (6) defines the range of the lateral magnification at the infinity focusing of the third lens group. If the conditional expression (6) is satisfied, appropriateness in the total optical length and aberration correction are achieved since the lateral magnification at the infinity focusing of the third lens group is proper. If the value of conditional expression (6) is less than the lower limit value, F-number of the optical system constituted by the first and second lens groups should be smaller and brighter and the focal length should be longer to realize a bright telephoto-type imaging lens since the lateral magnification of the third lens group is too small. As a result, a plenty of lenses are required for aberration correction to provide well focused image. That is, it is not preferable because the number of lenses constituting the imaging lens increases and the total optical length is made long. In contrast, if the value of conditional expression (6) exceeds the upper limit value, the lateral magnification of the third lens group is made too large, and a large number of lenses are required especially in the third lens group for aberration correction to provide well focused image. So, the total optical length is made long. Thus, the value exceeds the range of conditional expression (6) is not preferable since miniaturization of the imaging lens is made difficult.

In view of these viewpoints, the value of conditional expression (6) is more preferable to be in the range of following expression (6a) and further preferable to be in the range of following expression (6b).

0.20≦|B3|≦0.85 (6a)

0.25≦|B3|≦0.80 (6b)

### 1-3-7. Conditional Expression (7)

Conditional expression (7) will be described. The imaging lens according to the present invention is preferable to further satisfy following conditional expression (7) together with conditional expression (1) and (2) or conditional expression (1) and (3) described above.

0.28≦f1/f≦0.80 (7)

where
f1: Focal length of first lens group
f: Focal length of entire optical system at infinity focusing

Conditional expression (7) defines the ratio between the focal length of the first lens group and the focal length of the entire optical system at the infinity focusing. If the value is less than the lower limit value, the telephoto effect of the imaging lens is made insufficient since the focal length of the first lens group is too short and the total optical length against the focal length is made long. In contrast, if the value exceeds the upper limit value, aberration correction in the first lens group is made difficult since the focal length of the first lens group is too long. As a result, the number of lenses required for the aberration correction increases and the miniaturization of the imaging lens is made difficult.

In view of these viewpoints, the value of conditional expression (7) is more preferable to be in the range of following expression (7a) and further preferable to be in the range of following expression (7b).

0.30≦f1/f≦0.70 (7a)

0.32≦f1/f≦0.65 (7b)

### 2. Imaging Device

Embodiments of the imaging device according to the present invention will be described. The imaging device according to the present invention is characterized in including the imaging lens described above and a photographing element (imaging sensor) that converts an optical image formed on the focusing side by the imaging lens into an electrical signal. Note that the kind of the imaging sensor is not especially limited and the size of the imaging sensor is not especially limited also. The imaging lens according to the present invention is a telephoto-type imaging lens for short-distance imaging that achieves the miniaturization and weight reduction of a focusing lens group, the load on the drive system for focusing is reduced, the entire optical system is made compact and realize well focused image with a simple structure. So, application of the imaging lens to a lens-interchangeable-type camera such as a so-called single lens reflex camera is preferable because the imaging lens is compact, and further suitable for a miniature lens-interchangeable-type camera having a small body such as a mirror-less single lens camera. Further, the imaging lens is particularly suitable for devices for video-imaging among small imaging devices since the imaging lens according to the present invention enables high-speed focusing following the movement of an object. Note that, as the imaging device according to the present invention is not limited to these lens-interchangeable-type cameras, the imaging device may include a so-called digital camera or the like in which an imaging lens is fixed to the body without interchangeable and various kinds of electronic equipment such as a mobile phone and portable electronic equipment having a communication function in addition to a imaging function.

Present invention will be specifically demonstrated with reference to Examples and Comparative Examples. The matter should be noted that the present invention is not limited to the following examples, the lens structure described in the following examples merely exemplify the present invention, and it is natural that the lens structure of the imaging lens according to the present invention can be arbitrarily modified without departing from the scope of the present invention.

### Example 1

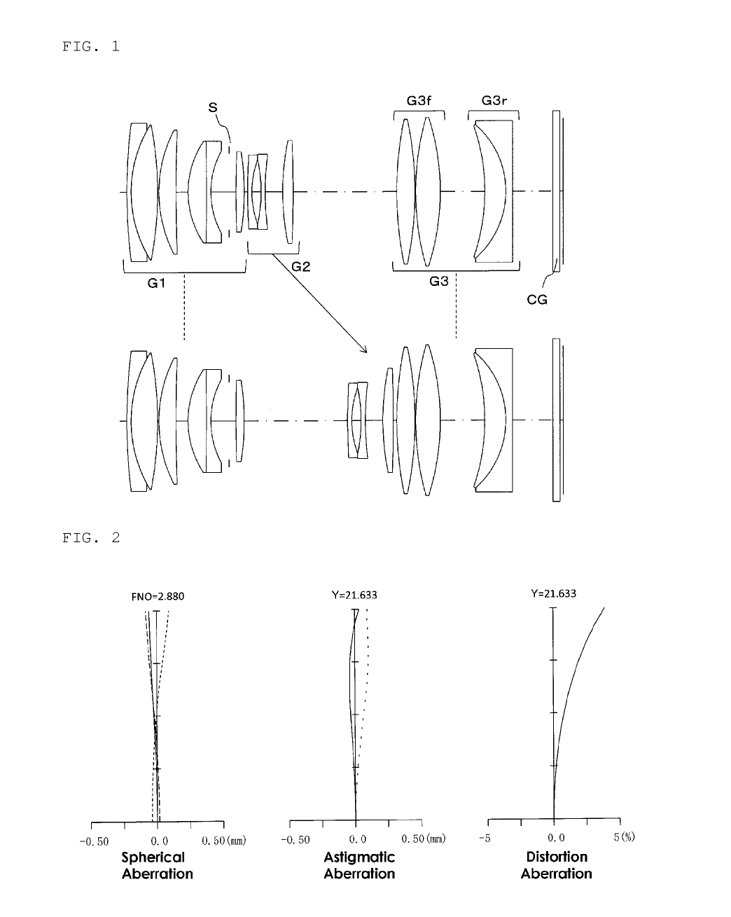

Examples of the imaging lens according to the present invention will be described with reference to the drawings. FIG. 1 is a figure exemplifying a lens structure of an optical system in Example 1. The top is a lens structure at the infinity object distance and the bottom is a lens structure at the closest-distance.

As shown in FIG. 1, the imaging lens in Example 1 includes first lens group G1 having positive refracting power, second lens group G2 having negative refracting power and third lens group G3 having positive refracting power disposed in order from the object side. Optical iris S is disposed in first lens group G1, and the second lens group includes one positive lens. The third lens group is constituted by front sub-lens group G3f having positive refracting power disposed at the object side and rear sub-lens group G3r having negative refracting power disposed at the focusing side with the largest on-axis air gap in the third lens group. In addition, optical filter CG is provided at the object side of the imaging sensor.

In the imaging lens, first lens group G1 and third lens group G3 are fixed lens groups in focusing, and the positions are fixed before and after focusing as shown by the dotted lines in the figure. In contrast, second lens group G2 is a focusing lens group moves to the focusing side in focusing from the infinity to a close object as shown by the arrow in the figure. Note that the specific lens structure of each lens group is as shown in FIG. 1.

Typical Numerical Values 1 showing specific values applied as lens data in Example 1 is shown in Table 1. Note that the lens data shown in Table 1 includes “r” (curvature radius of the lens surface), “d” (lens thickness or gap between adjacent lens surfaces on the optical axis), “Nd” (refractive index at the d-line (wavelength λ=587.6 nm)) and “ν(:nu)d” (Abbe number at the d-line) corresponding to each surface number of lens. Table 2 is variable gap table including “f” as the focal length of the entire system, “Fno.” as the F-number (FNO) and “ω (:omega)” as a half image viewing angle (°). These are common in Tables 3 to 10 described later. Each value of conditional expression (1) to (7) in Typical Numerical Values 1 is shown in Table 11. Note that f=92.742 (mm), FNO=2.880 and ω=12.654(°) in Table 1.

TABLE 1

| Surface No. | r | d | Nd | νd | |
|---|---|---|---|---|---|
| 1 | 158.747 | 1.200 | 1.9537 | 32.32 | |
| 2 | 36.343 | 7.541 | 1.4970 | 81.61 | |
| 3 | −99.568 | 0.375 | | | |
| 4 | 38.003 | 4.888 | 2.0006 | 25.46 | |
| 5 | 381.923 | 3.483 | | | |
| 6 | 25.759 | 5.339 | 1.4970 | 81.61 | |
| 7 | −610.766 | 1.200 | 1.9212 | 23.96 | |
| 8 | 24.249 | 5.257 | | | |
| 9 | INF | 2.000 | | | Aperture Stop |
| 10 | 600.545 | 2.307 | 1.9537 | 32.32 | |
| 11 | −73.483 | d11 | | | |
| 12 | 186.351 | 1.200 | 1.8830 | 40.81 | |
| 13 | 26.214 | 2.620 | | | |
| 14 | −44.401 | 1.200 | 1.4970 | 81.61 | |
| 15 | 78.780 | 5.022 | | | |
| 16 | 70.983 | 2.982 | 1.9229 | 20.88 | |
| 17 | −388.560 | d17 | | | |
| 18 | 100.839 | 5.234 | 1.4970 | 91.61 | |
| 19 | −96.866 | 0.200 | | | |
| 20 | 76.859 | 7.009 | 1.4970 | 81.61 | |
| 21 | −68.829 | 12.795 | | | |
| 22 | −55.270 | 6.007 | 1.7234 | 37.99 | |
| 23 | −24.934 | 2.000 | 1.8467 | 23.78 | |
| 24 | INF | 11.500 | | | |
| 25 | INF | 2.000 | 1.5168 | 64.20 | |
| 26 | INF | 1.000 | | | |

TABLE 2

| Image Size | Infinity | −0.5 times | −1.0 times |
|---|---|---|---|
| f | 92.742 | 67.284 | 43.796 |
| Fno. | 2.88 | 4.325 | 5.770 |
| d11 | 1.000 | 14.083 | 29.648 |
| d17 | 29.642 | 16.560 | 0.994 |

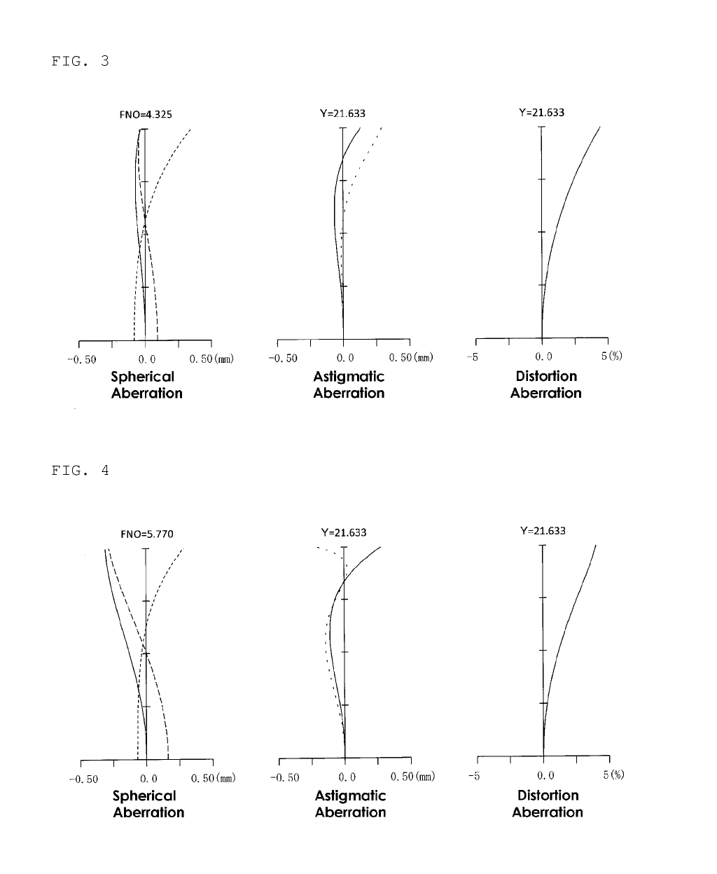

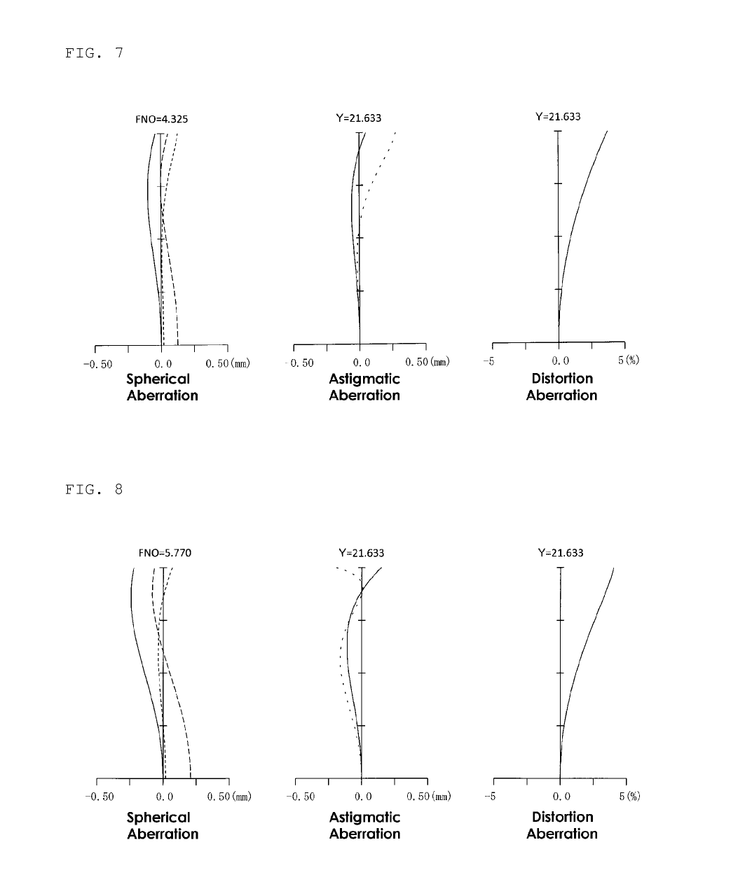

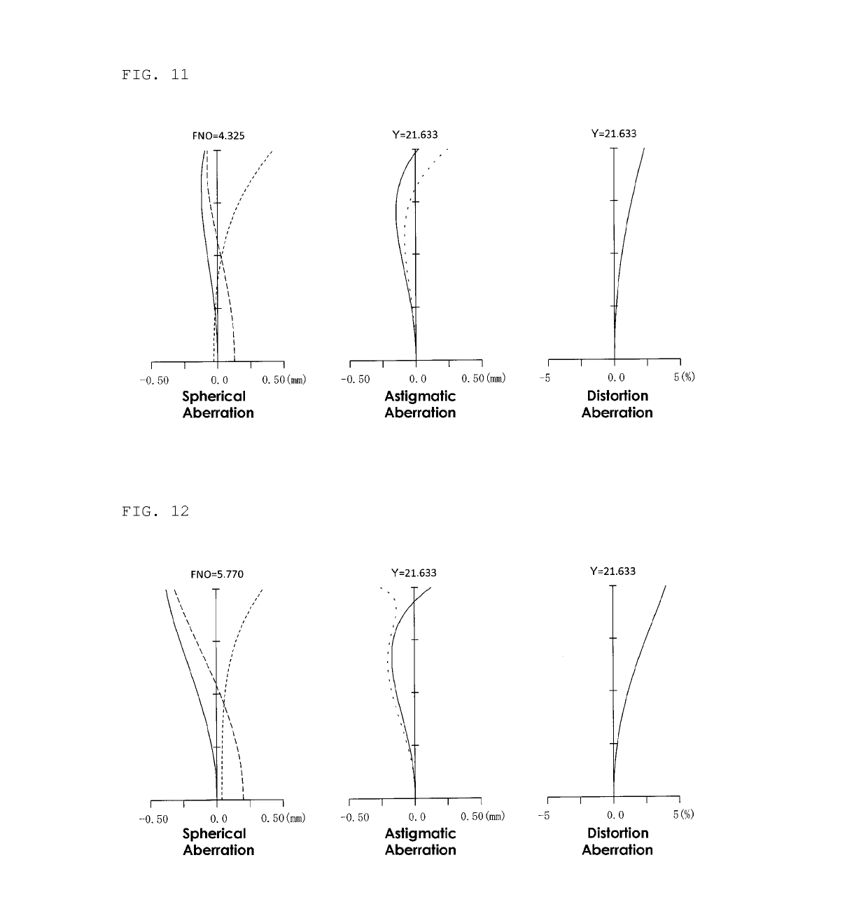

FIGS. 2 to 4 show the longitudinal aberration diagrams of spherical aberration, astigmatism aberration and distortion aberration at image size “0 times (Infinity)”, “−0.5 times” and “−1.0 times” of the optical system in Example 1. Each longitudinal aberration diagram shows the spherical aberration (SA (mm)), the astigmatism aberration (AST (mm)) and the distortion aberration (DIS (%)) in order from the left side of the figures. In the spherical aberration diagram, the vertical axis is the F-number (shown with “FNO” in the figure), the solid line shows the characteristic at the d-line (wavelength λ=587.6 nm), the short broken line shows the characteristic at the g-line (wavelength λ=435.8 nm) and the long broken line shows the characteristic at the C-line (wavelength λ=656.3 nm). In the astigmatism aberration diagram, the vertical axis is the image height (shown with “Y” in the figure), the solid line shows the characteristic of a sagittal plane and the broken line shows the characteristic of a meridional plane. In the distortion aberration diagram, the vertical axis is the image height (shown with “Y” in the figure). Note that these are common in FIGS. 6 to 8, 10 to 12. 14 to 16 and 18 to 20.

### Example 2

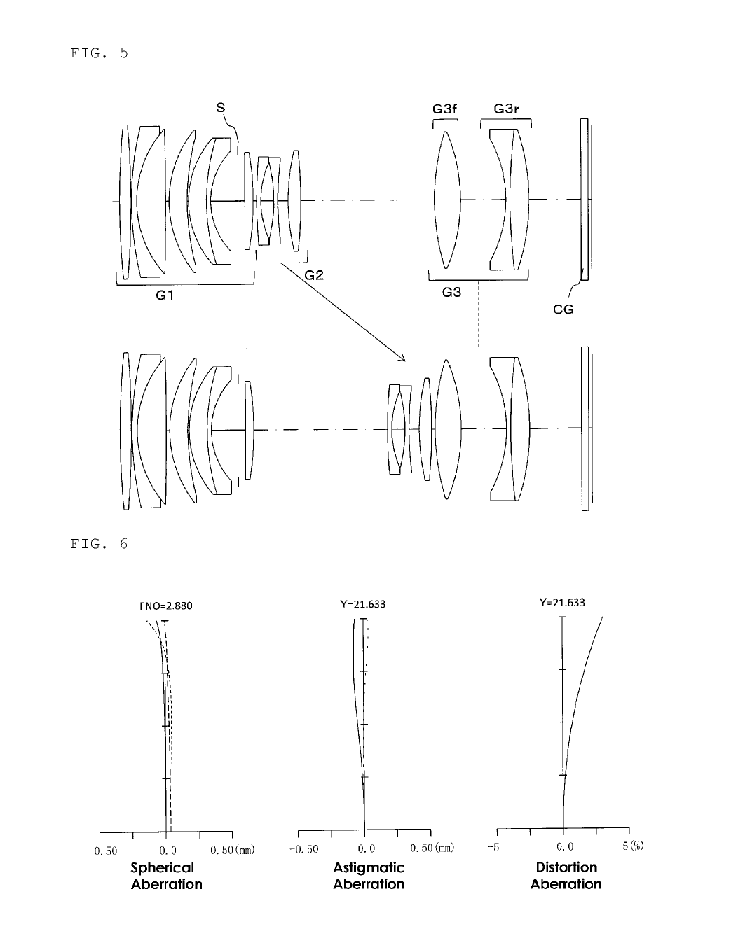

The imaging lens in Example 2 will be described with reference to the drawings. FIG. 5 is a figure exemplifying a lens structure of the imaging lens in Example 2. The imaging lens in Example 2 has almost the same structure as the imaging lens in Example 1 though the specific lens structure of each lens group is different. FIGS. 6 to 8 show the longitudinal aberration diagrams of spherical aberration, astigmatism aberration and distortion aberration in image size “0 times (Infinity)”, “−0.5 times” and “−1.0 times” of the imaging lens in Example 2.

Tables 3 and 4 show Typical Numerical Values 2 showing specific values. Note that f=116.425 (mm), FNO=2.880 and ω=10.221(°) in Table 3. Each value of conditional expression (1) to (7) in Typical Numerical Values 2 is shown in Table 11.

TABLE 3

| Surface No. | r | d | Nd | νd | |
|---|---|---|---|---|---|
| 1 | 220.262 | 3.235 | 1.6031 | 60.69 | |
| 2 | −267.484 | 0.200 | | | |
| 3 | 89.707 | 1.500 | 1.9037 | 31.31 | |
| 4 | 30.629 | 8.262 | 1.4970 | 81.61 | |
| 5 | −745.132 | 1.000 | | | |
| 6 | 31.983 | 5.201 | 2.0006 | 25.46 | |
| 7 | 70.523 | 0.387 | | | |
| 8 | 26.702 | 5.139 | 1.4970 | 81.61 | |
| 9 | 58.751 | 1.200 | 1.7847 | 25.72 | |
| 10 | 20.454 | 7.740 | | | |
| 11 | INF | 2.000 | | | Aperture Stop |
| 12 | −1601.561 | 2.376 | 1.8348 | 42.72 | |
| 13 | −83.813 | d13 | | | |
| 14 | 138.030 | 1.200 | 1.8830 | 40.81 | |
| 15 | 26.337 | 3.731 | | | |
| 16 | −42.990 | 1.200 | 1.4970 | 81.61 | |
| 17 | 99.239 | 2.911 | | | |
| 18 | 61.960 | 3.543 | 1.8467 | 23.78 | |
| 19 | −143.844 | d19 | | | |
| 20 | 64.524 | 7.481 | 1.4970 | 81.61 | |
| 21 | −49.525 | 12.947 | | | |
| 22 | −35.853 | 1.200 | 1.9212 | 23.96 | |
| 23 | 160.830 | 5.412 | 1.8348 | 42.72 | |
| 24 | −62.177 | 14.879 | | | |
| 25 | INF | 2.000 | 1.5168 | 64.20 | |
| 26 | INF | 1.000 | | | |

TABLE 4

| Image Size | Infinity | −0.5 times | −1.0 times |
|---|---|---|---|
| f | 116.425 | 85.947 | 55.216 |
| Fno. | 2.88 | 4.325 | 5.770 |
| D13 | 1.000 | 16.840 | 38.255 |
| D19 | 38.255 | 22.416 | 1.00 |

### Example 3

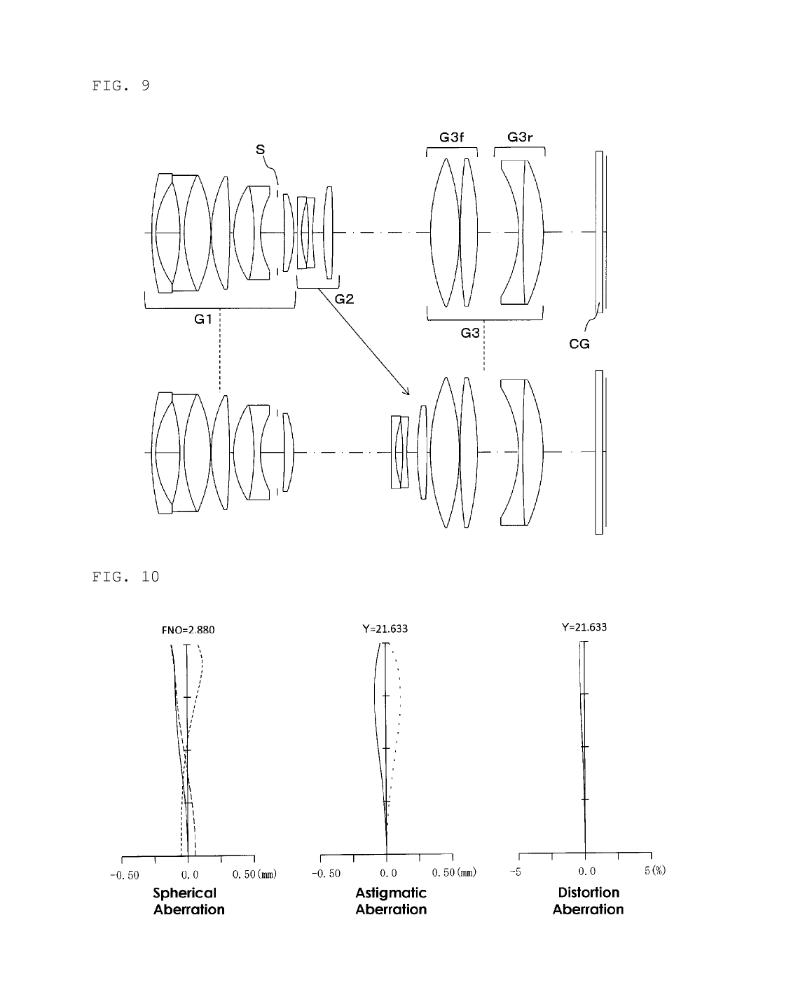

The imaging lens in Example 3 will be described with reference to the drawings. FIG. 9 is a figure exemplifying a lens structure of the imaging lens in Example 3. The imaging lens in Example 3 has almost the same structure as the imaging lens in Example 1 though the specific lens structure of each lens group is different. FIGS. 10 to 12 show the longitudinal aberration diagrams of spherical aberration, astigmatism aberration and distortion aberration in image size “0 times (Infinity)”, “−0.5 times” and “−1.0 times” of the imaging lens in Example 3.

Tables 5 and 6 show Typical Numerical Values 3 showing specific values. Note that f=61.833 (mm), FNO=2.880 and ω=19.343(°) in Table 3. Each value of conditional expression (1) to (7) in Typical Numerical Values 3 is shown in Table 11.

TABLE 5

| Surface No. | r | d | Nd | νd | |
|---|---|---|---|---|---|
| 1 | 70.877 | 1.200 | 1.5168 | 64.20 | |
| 2 | 24.652 | 6.873 | | | |
| 3 | −49.499 | 1.200 | 1.9537 | 32.32 | |
| 4 | 39.323 | 7.567 | 1.7725 | 49.62 | |
| 5 | −39.060 | 0.200 | | | |
| 6 | 36.091 | 5.295 | 2.0006 | 25.46 | |
| 7 | −171.825 | 1.137 | | | |
| 8 | 24.139 | 5.844 | 1.4970 | 81.61 | |
| 9 | −62.723 | 1.787 | 1.9212 | 23.96 | |
| 10 | 23.245 | 4.859 | | | |
| 11 | INF | 2.000 | | | Aperture Stop |
| 12 | −152.870 | 2.660 | 1.8830 | 40.81 | |
| 13 | −34.200 | d13 | | | |
| 14 | 1468.377 | 1.200 | 1.7433 | 49.22 | |
| 15 | 27.985 | 2.066 | | | |
| 16 | −65.765 | 1.200 | 1.6031 | 60.96 | |
| 17 | 80.393 | 3.015 | | | |
| 18 | 74.616 | 2.694 | 1.9229 | 20.88 | |
| 19 | −264.160 | d19 | | | |
| 20 | 53.883 | 8.279 | 1.4970 | 81.61 | |
| 21 | −63.227 | 0.200 | | | |
| 22 | 168.385 | 4.983 | 1.4970 | 81.61 | |
| 23 | −82.617 | 11.778 | | | |
| 24 | −35.093 | 1.200 | 1.8467 | 23.78 | |
| 25 | 387.808 | 5.813 | 1.4875 | 70.44 | |
| 26 | −48.874 | 14.981 | | | |
| 27 | INF | 2.000 | 1.5168 | 64.20 | |
| 28 | INF | 1.000 | | | |

TABLE 6

| Image Size | Infinity | −0.5 times | −1.0 times |
|---|---|---|---|
| f | 61.833 | 56.303 | 42.747 |
| Fno. | 2.880 | 4.325 | 5.770 |
| D13 | 1.001 | 13.659 | 27.967 |
| D19 | 27.967 | 15.309 | 1.001 |

### Example 4

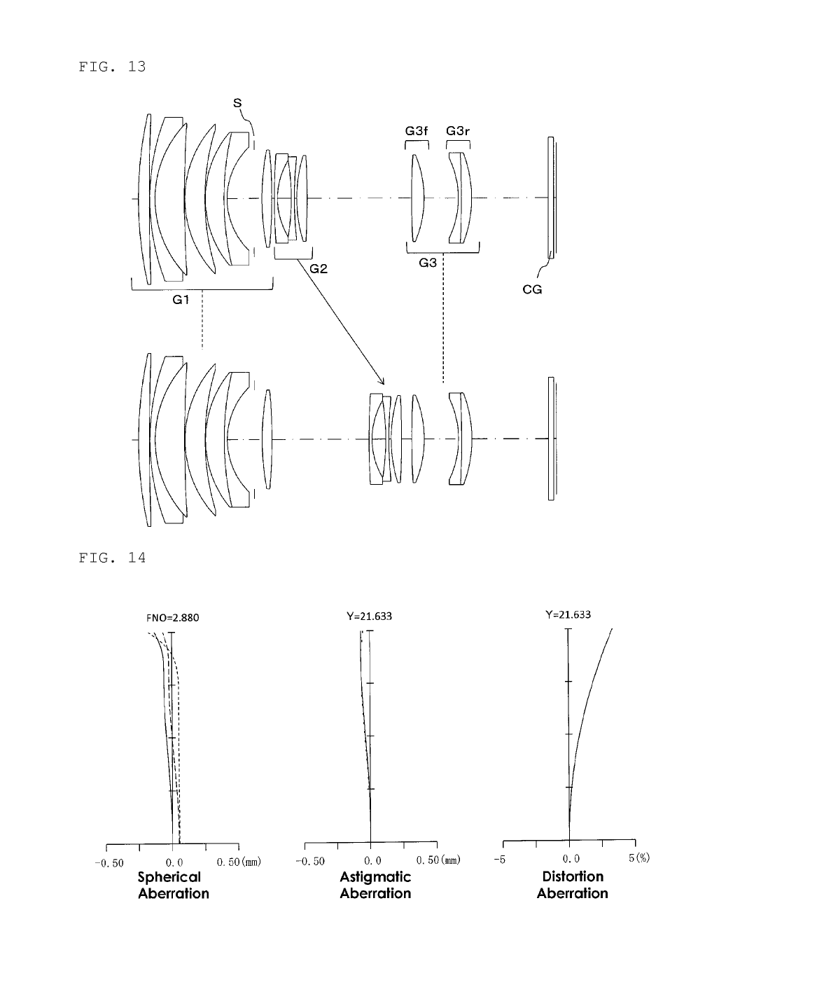

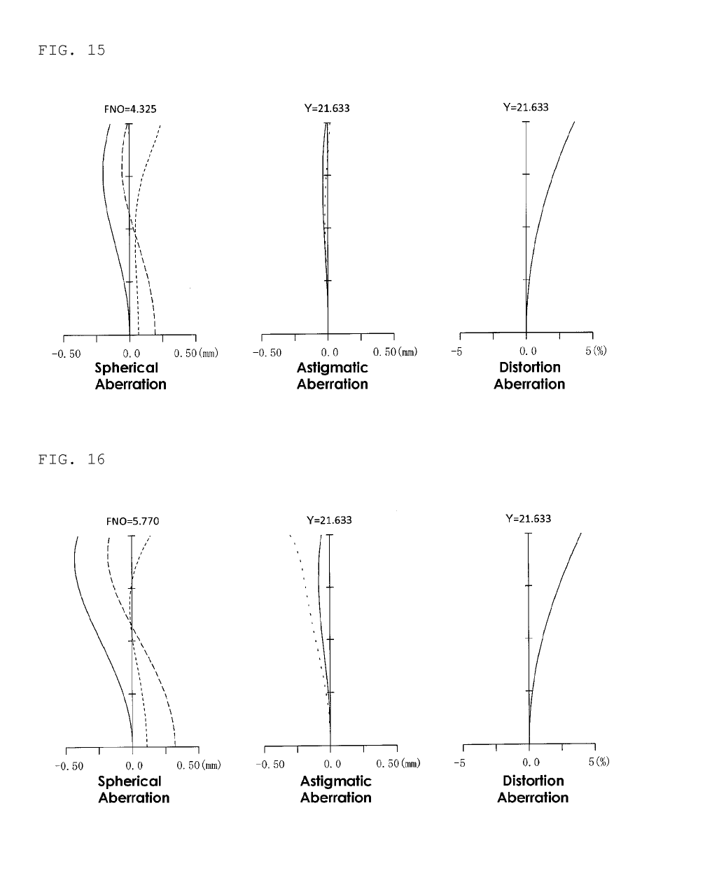

The imaging lens in Example 4 will be described with reference to the drawings. FIG. 13 is a figure exemplifying a lens structure of the imaging lens in Example 4. The imaging lens in Example 4 has almost the same structure as the imaging lens in Example 1 though the specific lens structure of each lens group is different. FIGS. 14 to 16 show the longitudinal aberration diagrams of spherical aberration, astigmatism aberration and distortion aberration in image size “0 times (Infinity)”, “−0.5 times” and “−1.0 times” of the imaging lens in Example 4.

Tables 7 and 8 show Typical Numerical Values 4 showing specific values. Note that f=174.569 (mm), FNO=2.880 and ω=6.842(°) in Table 3. Each value of conditional expression (1) to (7) in Typical Numerical Values 2 is shown in Table 11.

TABLE 7

| Surface No. | r | d | Nd | νd | |
|---|---|---|---|---|---|
| 1 | 145.620 | 4.149 | 1.8830 | 40.81 | |
| 2 | 788.136 | 0.200 | | | |
| 3 | 85.052 | 2.000 | 2.0006 | 25.46 | |
| 4 | 40.687 | 11.272 | 1.4970 | 81.61 | |
| 5 | 421.905 | 0.200 | | | |
| 6 | 40.413 | 7.677 | 2.0010 | 29.13 | |
| 7 | 87.953 | 0.200 | | | |
| 8 | 38.857 | 7.116 | 1.4970 | 81.61 | |
| 9 | 108.119 | 1.200 | 1.8061 | 33.27 | |
| 10 | 26.984 | 10.339 | | | |
| 11 | INF | 3.000 | | | Aperture Stop |
| 12 | 96.770 | 3.766 | 1.6385 | 55.45 | |
| 13 | −190.071 | d13 | | | |
| 14 | 242.448 | 1.200 | 1.8830 | 40.81 | |
| 15 | 27.842 | 5.209 | | | |
| 16 | −90.321 | 1.200 | 1.7433 | 49.22 | |
| 17 | 149.849 | 0.897 | | | |
| 18 | 54.735 | 3.954 | 1.9229 | 20.88 | |
| 19 | −326.234 | d19 | | | |
| 20 | 278.047 | 4.790 | 1.4970 | 81.61 | |
| 21 | −41.298 | 13.135 | | | |
| 22 | −33.992 | 1.200 | 2.0006 | 25.46 | |
| 23 | −318.674 | 3.910 | 1.6727 | 32.17 | |
| 24 | −46.454 | 29.339 | | | |
| 25 | INF | 2.000 | 1.5168 | 64.20 | |
| 26 | INF | 1.000 | | | |

TABLE 8

| Image Size | Infinity | −0.5 times | −1.0 times |
|---|---|---|---|
| f | 174.569 | 102.029 | 63.465 |
| Fno. | 2.880 | 4.325 | 5.770 |
| D13 | 1.002 | 16.605 | 37.116 |
| D19 | 40.044 | 24.441 | 3.930 |

### Example 5

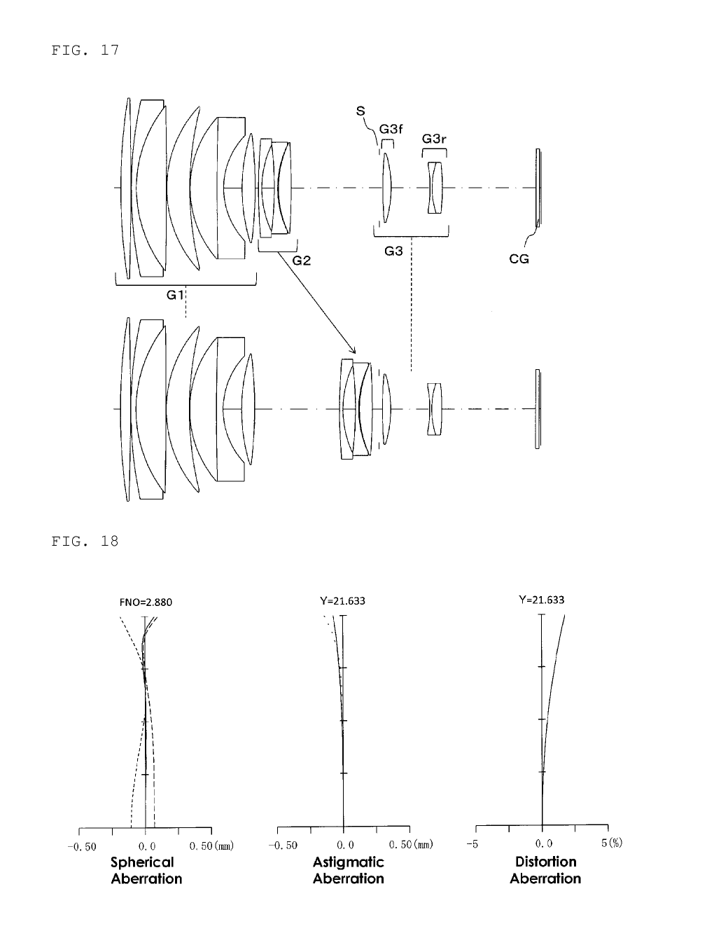

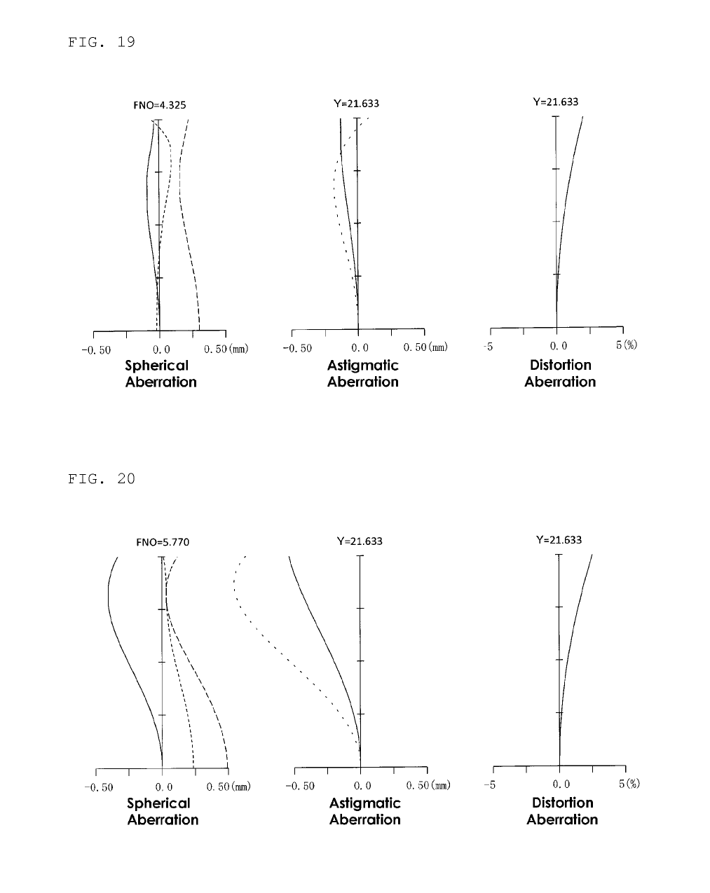

The imaging lens in Example 5 will be described with reference to the drawings. FIG. 17 is a figure exemplifying a lens structure of the imaging lens in Example 5. The imaging lens in Example 5 has almost the same structure as the imaging lens in Example 1 though there is a differences in the disposition of optical iris S between second lens group G2 and third lens group G3 and the specific lens structure of each lens group. FIGS. 18 to 20 show the longitudinal aberration diagrams of spherical aberration, astigmatism aberration and distortion aberration in image size “0 times (Infinity)”, “−0.5 times” and “−1.0 times” of the imaging lens in Example 5.

Tables 9 and 10 show Typical Numerical Values 5 showing specific values. Note that f=290.995 (mm), FNO=2.880 and ω=4.176(°) in Table 3. Each value of conditional expression (1) to (7) in Typical Numerical Values 2 is shown in Table 11.

TABLE 9

| Surface No. | r | d | Nd | νd | |
|---|---|---|---|---|---|
| 1 | 346.995 | 6.003 | 1.8830 | 40.81 | |
| 2 | −1763.390 | 0.200 | | | |
| 3 | 241.738 | 3.000 | 2.0006 | 25.46 | |
| 4 | 76.996 | 17.856 | 1.4970 | 81.61 | |
| 5 | −2999.551 | 0.200 | | | |
| 6 | 69.901 | 13.756 | 2.0010 | 29.13 | |
| 7 | 187.387 | 0.200 | | | |
| 8 | 62.260 | 15.963 | 1.4970 | 81.61 | |
| 9 | 1445.423 | 3.938 | 1.8340 | 37.35 | |
| 10 | 44.293 | 10.973 | | | |
| 11 | 105.278 | 7.786 | 1.5891 | 61.25 | |
| 12 | −251.342 | d12 | | | |
| 13 | 324.464 | 2.000 | 1.8830 | 40.81 | |
| 14 | 58.410 | 7.457 | | | |
| 15 | −201.178 | 2.000 | 1.8340 | 37.35 | |
| 16 | 58.274 | 0.453 | | | |
| 17 | 62.383 | 7.575 | 1.9229 | 20.88 | |
| 18 | −408.691 | d18 | | | |
| 19 | INF | 2.000 | | | Aperture Stop |
| 20 | 231.914 | 4.930 | 1.4970 | 81.61 | |
| 21 | −67.989 | 23.104 | | | |
| 22 | −72.725 | 1.200 | 2.0006 | 25.46 | |
| 23 | 46.430 | 6.031 | 1.8467 | 23.78 | |
| 24 | −143.175 | 55.811 | | | |
| 25 | INF | 2.000 | 1.5168 | 64.20 | |
| 26 | INF | 1.000 | | | |

TABLE 10

| Image Size | Infinity | −0.5 times | −1.0 times |
|---|---|---|---|
| f | 290.995 | 150.108 | 92.448 |
| Fno. | 2.880 | 4.325 | 5.770 |
| D12 | 1.999 | 23.595 | 50.491 |
| D18 | 52.567 | 30.971 | 4.075 |

TABLE 11

| | Example 1 | Example 2 | Example 3 | Example 4 | Example 5 |
|---|---|---|---|---|---|
| Conditional | 1.000 | 1.000 | 1.000 | 1.000 | 1.000 |
| Exp. (1) | | | | | |
| Conditional | 0.894 | 1.073 | 1.048 | 2.023 | 4.204 |
| Exp. (2) | | | | | |
| Conditional | 0.799 | 0.666 | 0.563 | 0.923 | 1.150 |
| Exp. (3) | | | | | |
| Conditional | 0.399 | 0.422 | 0.662 | 0.297 | 0.256 |
| Exp. (4) | | | | | |
| Conditional | 1.743 | 1.040 | 1.530 | 0.974 | 0.785 |
| Exp. (5) | | | | | |
| Conditional | 0.380 | 0.607 | 0.275 | 0.754 | 0.743 |
| Exp. (6) | | | | | |
| Conditional | 0.503 | 0.474 | 0.614 | 0.385 | 0.356 |
| Exp. (7) | | | | | |
| B | −1.000 | −1.000 | −1.000 | −1.000 | −1.000 |
| f3 | 82.909 | 124.886 | 64.773 | 353.103 | 1223.270 |
| f | 92.742 | 116.425 | 61.833 | 174.569 | 290.995 |
| f3f | 43.776 | 57.632 | 40.366 | 72.711 | 106.367 |
| f3r | −54.773 | −86.515 | −71.636 | −78.780 | −92.489 |
| f2 | −37.006 | −49.106 | −40.917 | −51.836 | −74.420 |
| f2p | 64.515 | 51.053 | 62.584 | 50.477 | 58.448 |
| B3 | 0.380 | 0.607 | 0.275 | 0.754 | 0.743 |
| f1 | 46.628 | 55.184 | 37.942 | 67.258 | 103.638 |

The imaging lens according to the present invention is a telephoto-type macro lens for short-distance imaging and an imaging device according to the present invention includes the telephoto-type macro lens. Employment of the lens structure and focusing method described above can achieves the miniaturization and weight reduction of a focusing lens group, reduction of the load on the drive system for focusing, compact structure of the entire optical system; and realizes well focused image with a simple structure. So, the imaging lens is suitable for an interchangeable lens for a miniature imaging device having a small body and the miniature imaging device. Further, the imaging lens is suitable for an interchangeable lens for a miniature imaging device that can perform video-imaging and the miniature imaging device because of easy focusing follows the movement of an object at high speed.

### SYMBOL LIST

G1 First lens group
G2 Second lens group
G3 Third lens group
G3f Front sub-lens group
G3r Rear sub-lens group
S Optical iris
CG Optical filter

1. An imaging lens comprising:
a first lens group having positive refracting power, a second lens group having negative refracting power and a third lens group having positive refracting power disposed in order from an object side, wherein
at least one positive lens comprises the second lens group;
wherein the first lens group and the third lens group are fixed and the second lens group moves to a focusing side in focusing from infinity to a close object; and
wherein the imaging lens satisfies conditional expressions (1) and (2) below.
0.50≦|B| (1)
0.70≦f3/f≦6.00 (2)
where
B: Maximum lateral magnification of an optical system
f3: Focal length of the third lens group
f: Focal length of the optical system at infinity focusing

2. An imaging lens comprising:
a first lens group having positive refracting power, a second lens group having negative refracting power and a third lens group having positive refracting power disposed in order from an object side, wherein
at least one positive lens comprises the second lens group;
wherein the third lens group includes a front sub-lens group having positive refracting power disposed at an object side and a rear sub-lens group having negative refracting power disposed at a focusing side with a largest on-axis air gap in the third lens group;
wherein the first lens group and the third lens group are fixed and the second lens group moves to the focusing side in focusing from infinity to a close object; and
wherein the imaging lens satisfies conditional expressions (1) and (3) below.
0.50≦|B| (1)
0.30≦f3f/|f3r|≦1.40 (3)
where
B: Maximum lateral magnification of an optical system
f3f: Focal length of the front sub-lens group of the third lens group
f3r: Focal length of the rear sub-lens group of the third lens group

3. The imaging lens according to claim 1, wherein the imaging lens satisfies conditional expression (4) below.
0.19≦|f2|/f≦0.90 (4)
where
f2: Focal length of the second lens group
f: Focal length of the optical system in infinity focusing

4. The imaging lens according to claim 1, wherein the imaging lens satisfies conditional expression (5) below.
0.70≦f2/|f2|≦2.20 (5)
where
f2p: Focal length of positive lens in the second lens group
f2: Focal length of the second lens group

5. The imaging lens according to claim 1, wherein the imaging lens satisfies conditional expression (6) below.
0.15≦|B3|≦0.90 (6)
where
B3: Lateral magnification at infinity focusing of the third lens group

6. The imaging lens according to claim 1, wherein the imaging lens satisfies conditional expression (7) below:
0.28≦f1/f≦0.80 (7)
where
f1: Focal length of the first lens group
f: Focal length of the optical system at infinity focusing

7. The imaging lens according to claim 2, wherein the imaging lens satisfies conditional expression (4) below.
0.19≦|f2|/f≦0.90 (4)
where
f2: Focal length of the second lens group
f: Focal length of the optical system in infinity focusing

8. The imaging lens according to claim 2, wherein the imaging lens satisfies conditional expression (5) below.
0.70≦f2p/|f2|≦2.20 (5)
where
f2p: Focal length of positive lens in the second lens group
f2: Focal length of the second lens group

9. The imaging lens according to claim 2, wherein the imaging lens satisfies conditional expression (6) below.
0.15≦|B3|≦0.90 (6)
where
B3: Lateral magnification at infinity focusing of the third lens group

10. The imaging lens according to claim 2, wherein the imaging lens satisfies conditional expression (7) below:
0.28≦f1/f≦0.80 (7)
where
f1: Focal length of the first lens group
f: Focal length of the optical system at infinity focusing
